(19) United States
(12) Patent Application Publication
(10) Pub. No.: US 2020/0204106 A1
(43) Pub. Date: Jun. 25, 2020

(54) REFLECTIVE SOLAR APPARATUS

(71) Applicants: Xiaoping Hu, Shenzhen, Guangdong (CN); BOLYMEDIA HOLDINGS CO. LTD., Santa Clara, CA (US)

(72) Inventor: Xiaoping HU, Shenzhen (CN)

(73) Assignee: Bolymedia Holdings Co. Ltd., Santa Clara, CA (US)

(21) Appl. No.: 16/619,491

(22) PCT Filed: Jun. 19, 2017
(86) PCT No.: PCT/CN2017/088949

§ 371 Date: Dec. 5, 2019

(51) Int. Cl. H02S 20/32; F24S 20/50; F24S 23/30; F24S 23/70

(52) U.S. Cl. CPC H02S 20/32; F24S 23/70; F24S 23/31; F24S 20/50

(57) ABSTRACT

Disclosed is a reflective solar apparatus comprising a light receiving device and at least one light reflecting device. The light receiving device delimits a first light receiving surface used for receiving sunlight. The light reflecting device is provided on a side face of the first light receiving surface and has a curtain-type reflecting surface and a driving mechanism used for driving the curtain-type reflecting surface to expand and retract. When the curtain-type reflecting face is completely or partially expanded, sunlight reaching the curtain-type reflecting surface is at least partially guided to an area where the first light receiving surface is located. Since a curtain-type reflecting surface able to expanded or retract is used, not only can the sun be tracked but also the curtain-type reflecting surface can be expanded or retracted according to the strength of wind power.

### TECHNICAL FIELD

The present disclosure relates to clean energy, and in particular to reflective solar apparatus.

### PRIOR ART

With increasing focus on environmental protection, solar energy systems are growing in popularity.

There generally have been three methods to increase solar energy utilization per unit area:

1. increasing the efficiency of a light energy utilizing device,

2. using a concentrating system, and

3. tracking the direction of the sun.

Many concentrating systems needs to be used with a sun-tracking system simultaneously to achieve better results. However, since the current sun-tracking system primarily adopts a method for local tracking, that is dividing the light energy utilizing device into a plurality of small pieces, each piece arranged on a sun-tracking device, resulting in high cost, long installation time and inefficient use of occupied area.

However, when using a global tracking method, all the light energy utilizing devices share a sun-tracking system, leading to a larger area for sun tracking, therefore it may be weaker in wind resistance. Further, a strong structural material may and also be needed for support, which makes the entire device more cumbersome.

Therefore, it is necessary to develop a solar energy system that has high wind resistance, global tracking, and a certain concentrating ability.

### SUMMARY OF THE INVENTION

A reflective solar apparatus according to the present disclosure includes a light receiving device and at least a light reflecting device. The light receiving device may delimit a first light receiving surface used for receiving sunlight; and the light receiving device can be a light energy utilizing device or a combination of a light energy utilizing device and a light guiding device. The light reflecting device is arranged at the side surface of the first light receiving surface and provided with a curtain-type reflecting surface and a driving mechanism. The driving mechanism enables the curtain-type reflecting surface to switch between an expanded state and a retracted state. The area of the curtain-type reflecting surface is larger in the expanded state than that in the retracted state, and when the curtain-type reflecting surface is completely or partially expanded, the sunlight reaching the curtain-type reflecting surface is at least partially guided to a region where the first light receiving surface is located.

With the solar apparatus of the present disclosure, the light energy utilizing device can be stationary (or immobile with respect to a carrier such as a ship or a platform), so it is convenient to be put together and perform sun tracking globally by the light reflecting device provided on the side thereof. Specifically, at least one light reflecting device adopts a curtain-type reflecting surface capable of being expanded and retracted, and the reflecting surface can be retracted according to the position of the sun so that the sunlight passes directly, or the reflecting surface is expanded to reflect the sunlight, maximizing the amount of sunlight obtained by the light energy utilizing device.

By adopting the curtain-type reflecting surface, the weight of the apparatus can be reduced, and the curtain-type reflecting surface can be expanded or retracted according to the strength of the wind, thereby improving the wind resistance of the apparatus. Therefore, it is suitable for use as a photovoltaic power station in a strong wind zone. Since the solar apparatus according to the present disclosure is light and compact, it is also suitable for use as a mobile photovoltaic power plant.

Specific examples according to the present disclosure are described in detail below with reference to the accompanying drawings. As used herein, the serial numbers or sequence numbers used herein, such as “first”, “second”, etc., are merely illustrative without any restrictive meanings.

### BRIEF DESCRIPTION OF THE DRAWINGS

FIG. 1 is a schematic view of a reflective solar apparatus of Embodiment 1;

FIG. 2 is a schematic view of a reflective solar apparatus of Embodiment 2; and

FIG. 3 is a schematic view of a reflective solar apparatus of Embodiment 3.

### DETAILED DESCRIPTION

### Embodiment 1

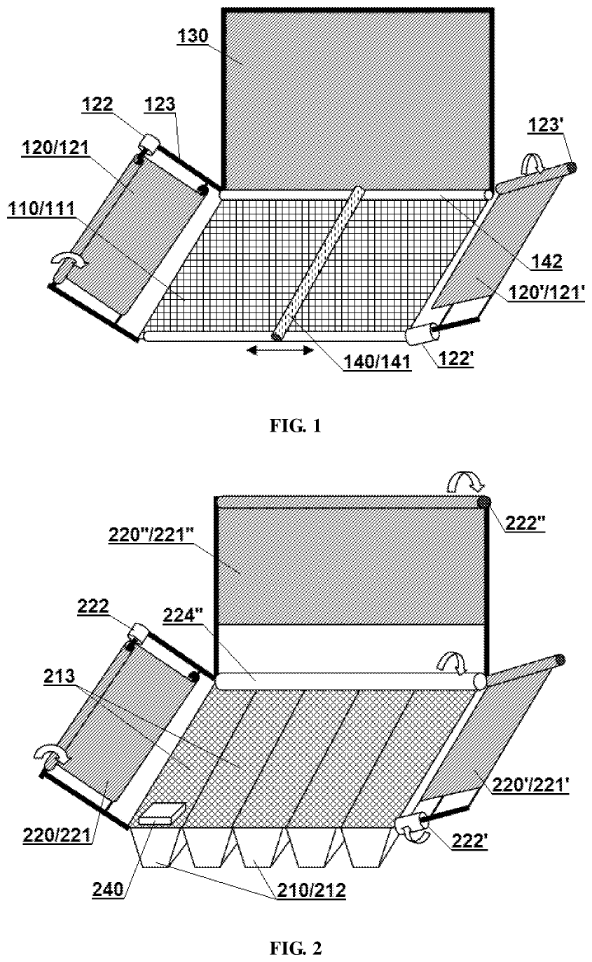

Referring to FIG. 1, a reflective solar apparatus according to one embodiment of the present disclosure is schematically shown. The reflective solar apparatus may include a light receiving device 110, two light reflecting devices 120, 120′ having movable reflecting surfaces, and a light reflecting device 130 having a fixed reflecting surface.

The light receiving device 110 delimits a first light receiving surface for receiving sunlight. It may be a light energy utilizing device or a combination of a light energy utilizing device and a light guiding device, for example, a light energy utilizing device with a light concentrating unit. When the light receiving device includes only the light energy utilizing device, the surface of the light energy utilizing device is the first light receiving surface, while when the light receiving device is further provided with a light guiding device in front of its optical path, the light receiving surface of the light guiding device is the first light receiving surface.

A light energy utilization device generally refers to various devices that convert light energy into other energy, including a photovoltaic utilization device or a photothermal utilization device or a combination of both. Photovoltaic utilization devices include photovoltaic panels of various materials, photovoltaic thin films, quantum-dot photovoltaic panels, and the like. The photothermal utilization device includes a thermal energy storage device, a thermoelectric conversion device, a Stirling generator, a thermal power generator, and the like. Photovoltaic utilization devices can be cascaded with thermal energy utilization devices to achieve higher solar energy utilization efficiency. In this embodiment, the photovoltaic panel 111 is used as a light energy utilizing device, and the surface thereof is the first light receiving surface.

The light reflecting devices 120, 120′ each have a curtain-type reflecting surface 121, 121′ and a driving mechanism 122, 122′. Each curtain-type reflecting surface can be driven by the corresponding driving mechanism to switch between an expanded state and a retracted state, wherein the curtain-type reflecting surface has a larger surface area in the expanded state than that in the retracted state. The curtain-type reflecting surface may be fully or partially expanded, and when the curtain-type reflecting surface is in a fully or partially expanded state, sunlight reaching the curtain-type reflecting surface is at least partially incident to the area where the first light receiving surface is located. Curtain-type reflective surfaces can be expanded in a variety of ways, including rolled-up, sliding, and folding.

The curtain-type reflecting surface can be formed by a specular mirror or a reflective Fresnel lens. The reflective Fresnel lens may include a reflective concentrating Fresnel lens (for example, a reflective linear concentrating Fresnel lens), a reflective linear astigmatic Fresnel lens, and the like. As used herein, “concentrating” or “astigmatic” refers to concentrating light toward the optical center of the lens or diffusing out of the optical center. A Fresnel lens having a tooth surface originated from a convex lens surface (or a concave lens surface) is usually regarded as a concentrating (or astigmatic) Fresnel lens. The so-called “linear” Fresnel lens may mean that the focus center of the lens is a line instead of being concentrated at one point. The tooth surfaces of the linear Fresnel lens may be originated from a concave (or convex) cylindrical surface, or a concave (or convex) polynomial cylindrical surface. Since the linear astigmatic lens enables the light to be diverged in only one direction, it can be used to reflect the sunlight that illuminates the flanks to the first light receiving surface, thereby actually concentrating light.

In order to facilitate expansion and retraction, the component forming the curtain-type reflecting surface may be made of a flexible material, such as a reflective film on a flexible substrate, or a Fresnel lens made of a flexible material and coated on the back side. Alternatively, the reflecting surface can also be fabricated from segments made of rigid material and joined by moving parts to provide flexibility to the entire reflecting surface. The expanded state of the curtain-type reflecting surface can be designed as needed, and can be a plane or a curved surface.

The driving mechanism of the curtain-type reflecting surface can be similar to various available devices for rewinding or opening conventional curtains, so it can be inexpensive. For example, the drive mechanism can expand or retract the curtain-type reflecting surface in a rotating or stretching manner. Two types of driving mechanisms are exemplarily shown in this embodiment: the motor of one type of driving mechanism 122 unfolds or retracts the reflecting surface 121 along a guiding rod 123 in a rolling-over manner; and the motor of another type of the driving mechanism 122′ spreads the reflecting surface 121′ in a stretching manner, wherein the reflecting surface 121′ is automatically rolled up by a supporting shaft 123′ having a torsion spring (not shown), and the expansion of the reflecting surface 121′ is adjusted by the force balance between the driving force of the motor and the pulling force of the supporting shaft, in this aspect, the motor of the drive mechanism 122′ needs to be provided with a self-locking function to maintain the reflecting surface in a desired position.

Preferably, the retraction of the curtain-type reflecting surface is in a scroll state to save space, and its central axis may be parallel or perpendicular to the edge of the first light receiving surface. For example, in FIG. 1, the scroll formed after the reflecting surface 121 is retracted is parallel to the edge of the first light receiving surface, and the scroll formed after the reflecting surface 121′ is retracted is perpendicular to the edge of the first light receiving surface.

The light reflecting device is arranged on the flank of the first light receiving surface, and it realizes the sun tracking and the convergence of the sunlight by the expansion and retraction of the curtain-type reflecting surface, wherein the sunlight can be directly passed through or reflected according to the position of the sun. Since the reflection of the reflecting surface to the light also makes the effect of concentrating sunlight to some extent, the positional relationship between the reflecting surface and the first light receiving surface can be designed as needed to obtain better concentrating. For example, when the expanded state of the reflecting surface is a curved surface surrounding the first light receiving surface, its central normal may be perpendicular to the central normal of the first light receiving surface; or when the expanded state of the reflecting surface is on a plane of one side of the first light receiving surface, its central normal may form an inclined angle with respect to the central normal of the first light receiving surface, the inclined angle being generally greater than 30 degrees and less than 75 degrees, preferably less than 70 degrees. In other embodiment, preferably, the light reflecting device may further include an angle adjusting mechanism through which the light reflecting device may be mounted on one side of the first light receiving surface, so that the inclined angle of the reflecting surface can be adjusted to better adapting to the positional changes of the sun, directing more sunlight onto the first receiving surface.

In this embodiment, three light reflecting devices are provided, which include a stationary-type reflecting surface and two curtain-type reflecting surfaces. In other embodiment, a different number of reflecting surfaces can also be provided. Since the reflecting surfaces are mainly to reflect the sunlight onto the first light receiving surface, the orientation of each reflecting surface can be arranged according to the geographical position where the apparatus is to be mounted. For example, when only one light reflecting device is provided, the reflecting surface may be arranged on the north side or the south side of the first light receiving surface according to being mounted in the northern hemisphere or the southern hemisphere; when two light reflecting devices is provided, one reflecting surface may be arranged on the east side or the west side of the first light receiving surface (preferably on the east side), and the other reflecting surface may be arranged on the north side or the south side of the first light receiving surface; when three light reflecting devices is provided, two reflecting surfaces may be disposed respectively on the east side and the west side of the first light receiving surface, and the third reflecting surface may be disposed on the north side or the south side of the first light receiving surface.

In this embodiment, the light receiving device simply employs a monolithic photovoltaic panel. In other embodiment, the light-receiving device may also be formed by a plurality of light energy utilizing devices (or a plurality of light energy utilizing devices with light guiding devices) being put together. Since the light receiving device is stationary (or immobile with respect to a carrier of the entire apparatus), the light energy utilizing devices can be densely arranged and laid substantially flat, for example, in an array that is closely arranged. When the angle between the normal line of the first light receiving surface and the gravity direction of its position is less than 30 degrees, it can be regarded as “laid substantially flat”. The benefits of concentrating all of the light energy utilizing devices are as follows:

1. improving land use efficiency;

2. enhancing wind resistance of the apparatus by the light energy utilizing devices laid flat and arranged densely, and helping to reduce the overall height of the apparatus; and

3. facilitating cleaning the surfaces of the light energy utilizing devices being easy to accumulate dust after they are put together.

As a preferred embodiment, the solar apparatus according to this embodiment may further include a cleaning device 140 arranged on the surface of the first light receiving surface for cleaning the first light receiving surface. Specifically, the cleaning device in this embodiment is a vacuum cleaner of a sliding rod type, wherein the sliding rod 141 can move along a guiding rod 142 on the first light receiving surface, collecting dust on the first light receiving surface through a suction hole (not shown) on the sliding rod. In other embodiment, different types of cleaning devices, including a disc-type vacuum cleaner of a disc type that can move freely, can also be employed.

Preferably, the solar apparatus according to the present invention may further comprise a controller (not shown) for controlling the drive mechanism to expand or retract the curtain-type reflecting surface according to a control signal to automatically track sun or resist wind. The control signal may be from other devices arranged within or outside the apparatus. For example, the control signal may be at least one selected from the group consisting of: a signal from a clock, a signal from an external wind speed and direction measuring device, and manual instructions or weather forecast information received by a wired or wireless communication device. Based on these control signals, it can be determined whether the reflecting surface needs to be unfolded or retracted based on time (including seasons) and weather conditions (including wind power and direction).

### Embodiment 2

Referring to FIG. 2, a reflective solar apparatus according to another embodiment of the present disclosure is schematically shown. The reflective solar apparatus may include a light receiving device 210, three light reflecting devices 220, 220′, 220″ having movable reflecting surfaces, and a cleaning device 240.

Different from Embodiment 1, the light receiving device 210 in this embodiment is integrated by a plurality of units combined by a light energy utilizing device and a light guiding device, making the apparatus having a high concentration ratio. Each unit may include a tapered light guiding barrel 212 having an inner wall as a reflecting surface, and each light guiding barrel is provided at its larger end with a concentrating Fresnel lens 213 which is used as a photovoltaic panel of the light energy utilizing device (not shown) arranged at the bottom of the tapered light guiding barrel. The Fresnel lens 213 and the tapered light guiding barrel 212 together form a light concentrating unit on the optical path in front of the photovoltaic panel. The surface of all Fresnel lenses is formed as the first light receiving surface. In other embodiment, other types or other combinations of light guiding devices may be employed to increase the concentration ratio on the light energy utilizing device.

The light reflecting devices 220, 220′ are arranged on the east side and the west side of the first light receiving surface, respectively. The structure thereof is similar to that of the light reflecting devices 120, 120′ in Embodiment 1, respectively, unfolding and retracting the reflecting surfaces 221, 221′ by the motors 222, 222′, so the detailed structure here will not be described again.

The light reflecting device 220″ is arranged on the south side or the north side of the first light receiving surface, and the motor of its driving mechanism 222″ expands or retracts the reflecting surface 221″ in a rolled-over manner. As a preferred embodiment, the light reflecting device 220″ is attached to the side surface of the light receiving device by an angle adjusting arrangement, that is, a rotating shaft 224″, so that the inclined angle of the light receiving surface 221″ can be adjusted according to the season change.

The cleaning device 240 in this embodiment is different from that in Embodiment 1, specifically it adopts a disc-type vacuum cleaner that can move freely. The vacuum cleaner may be placed on the first light receiving surface, and can be charged wirelessly or be automatically charged by a photovoltaic panel located on its top.

### Embodiment 3

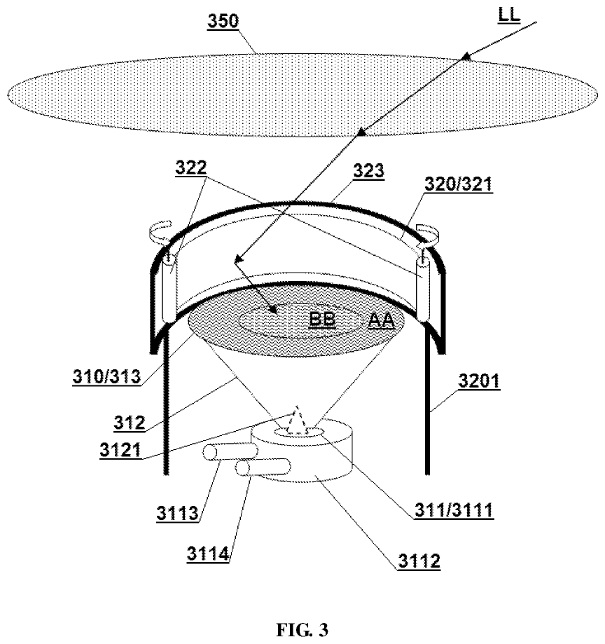

Referring to FIG. 3, a reflective solar apparatus according to still another embodiment of the present disclosure is schematically shown. The reflective solar apparatus may include a light receiving device 310 and a light reflecting device 320.

The light receiving device in this embodiment has a relatively complicated form and is a combination of a light energy utilizing device and a light guiding device. The light guiding device may include a tapered light guiding tube 312 and a concentrating Fresnel lens 313. The concentrating Fresnel lens 313 is arranged at one end of a larger opening of the tapered light guiding tube 312, and its surface is formed as the first light receiving surface.

As a preferred embodiment, the concentrating Fresnel lens in this embodiment may be a multi-focus composite Fresnel lens, and its surface is divided into different regions AA, BB according to the distances from its central optical axis, wherein the region AA farther to the central optical axis has a shorter focal length, and the region BB closer to the central optical axis has a longer focal length, so that the light intensity distribution on the focal plane is relatively uniform. The multi-focus composite Fresnel lens can be considered to be formed by combining a plurality of Fresnel lenses according to a certain structure and pattern.

The light energy utilizing device 311 is a container having two closed cavities 3111, 3112, and the inner cavity 3111 is nested inside the outer cavity 3112. The bottom of the tapered light guide tube 312 is provided with a tapered light guiding opening 3121. The larger end of the light guiding opening faces the inner layer cavity 3111, guiding the light into the inner layer cavity, and making it uneasy for the light to be reflected out of the inner cavity. A working medium may be stored in the outer cavity 3112 configured for storing and utilizing the heat generated by sunlight. The outer cavity may be provided with interfaces 3113, 3114 configured for the entry and exit of the working medium, and also for the entry and exit of a heat exchanging pipe. When they are used for the entry and exit of the heat exchanging pipe, the working medium in the outer cavity can be closed and only exchanged heat with external environment without material exchange.

The light energy utilizing device 311 may be a simple photothermal utilizing device or a combination of a photovoltaic utilizing device and a photothermal utilizing device. When it is the simple one, the inner cavity is configured for heat collection, while the outer cavity may be a liquid vaporizing tank or a thermal energy storage tank (such as a molten salt storage tank) and can generate electricity by connecting with an external thermal power generation system. When it is the combination, the inner wall of the inner cavity may be provided with a photovoltaic conversing device (such as a photovoltaic panel or a photovoltaic film), while the outer cavity may be provided with a working medium having a lower vaporizing temperature (such as alcohol, coolant or ammonia water) to reuse the heat energy generated by the photovoltaic conversing device.

The light reflecting device 320 is supported on the side of the first light receiving surface by a support member 3201, and has a curtain-type reflecting surface 321 and a driving mechanism 322. The driving mechanism 322 includes two rollers that are rotatable along a curved guide rail 323, and the reflecting surface 321 is wound around the two rollers. When the two rollers are respectively rolled to the both ends of the guide rail along the curved guide rails, the reflecting surface 321 is unfolded to be a curved surface, covering the side faces of the first light receiving surface in three directions. In the case of strong winds, the two rollers can be rolled to the center along the curved guide rails, so that the reflecting surface 321 is completely retracted to protect the reflecting surface and the solar apparatus from wind.

As a preferred embodiment, the solar apparatus of the embodiment may further include a front-end light concentrating unit 350 arranged on the optical path before the light reflecting device to obtain a higher concentration ratio. In this embodiment, the front-end light concentrating unit specifically adopts a gas lens arranged above the reflecting device. In other embodiment, any device capable of concentrating sunlight may be employed as the front-end light concentrating device, such as a concentrating Fresnel lens or the like.

The so-called gas lens is formed by filling a gas in a closed cavity which is at least partially transparent, wherein the gas may preferably be a gas having a density lower than that of air so that the gas lens can be suspended above the apparatus. In order to increase the concentration ratio, the cavity wall of the gas lens may be formed by a Fresnel lens so as to form a Fresnel gas lens. The incident sunlight LL is first concentrated by the gas lens 350 and then directly or again reflected by the reflecting surface 321 to reach the first light receiving surface.

The principle and implementation manners present disclosure have been described above with reference to the specific examples, which are merely provided for the purpose of understanding the present disclosure and are not intended to limit the present disclosure. It will be possible for those skilled in the art to make variations based on the principle of the present disclosure.

1. A reflective solar apparatus, comprising:
a light receiving device configured for delimiting a first light-receiving face used for receiving sunlight; the light receiving device being a light energy utilizing device or a combination of a light energy utilizing device and a light guiding device; and
at least a light reflecting device arranged at the side surface of the first light receiving surface and provided with a curtain-type reflecting surface and a driving mechanism, wherein the driving mechanism enables the curtain-type reflecting surface to switch between an expanded state and a retracted state, the area of the curtain-type reflecting surface is larger in the expanded state than that in the retracted state, and
when the curtain-type reflecting surface is completely or partially expanded, the sunlight reaching the curtain-type reflecting surface is at least partially guided to a region where the first light receiving surface is located;
wherein
the curtain-type reflecting surface being a plane or a curved surface in the expanded state,
the curtain-type reflecting surface being expanded or retracted by the driving mechanism in a revolved or stretching manner, and
the curtain-type reflecting surface being a scroll in the retracted state with its central axis parallel to or perpendicular to the edge of the first light receiving surface.

2. (canceled)

3. The solar apparatus according to claim 1, wherein the curtain-type reflecting surface is formed by one or several devices selected from the group consisting of: a specular mirror, a reflective concentrating Fresnel lens, and a reflective linear astigmatic Fresnel lens.

4. The solar apparatus according to claim 1, wherein the curtain-type reflecting surface is a curved surface surrounded the first light receiving surface in the expanded state with its central normal perpendicular to the central normal of the first light receiving surface, or
the curtain-type reflecting surface is a plane at a side of the first light receiving surface in the expanded state with its central normal forming an inclined angle with respect to the central normal of the first light receiving surface, the inclined angle being greater than 30 degrees and less than 75 degrees.

5. The solar apparatus according to claim 4, wherein the light reflecting device further comprises an angle adjusting arrangement by which the light reflecting device is installed at a side of the first light receiving surface so as to adjust the inclined angle.

6. The solar apparatus according to claim 1,
wherein there is one light reflecting device with its curtain-type reflecting surface arranged on the south side or north side of the first light receiving surface; or,
there are two light reflecting devices with one curtain-type reflecting surface arranged on the east side or west side of the first light receiving surface and another curtain-type reflecting surface on the south side or north side of the first light receiving surface; or,
there are three light reflecting devices with two curtain-type reflecting surface arranged on the east side of first light receiving surface and the third curtain-type reflecting surface on the south side or north side of the first light receiving surface.

7. The solar apparatus according to claim 1, wherein
the light energy utilizing device of the light receiving device is selected from a photovoltaic utilizing unit or a photothermal utilizing unit or a combination thereof, and
the light guiding device of the light receiving device comprises at least one selected from the group consisting of: a concentrating Fresnel lens, and a tapered light guiding barrel having an inner wall as the reflecting surface.

8. The solar apparatus according to claim 7, wherein the concentrating Fresnel lens of the light guiding device is a multi-focus composite Fresnel lens, the multi-focus composite Fresnel lens is divided into different regions according to the distances from its central optical axis, wherein the region farther to the central optical axis has a shorter focal length, and the region closer to the central optical axis has a longer focal length.

9. The solar apparatus according to claim 1, further comprising a front-end light concentrating unit arranged on the optical path before the light reflecting device and selected from a concentrating Fresnel lens or a gas lens,
wherein the gas lens is formed by filling a gas in a closed cavity which is at least partially transparent, the gas lens includes a Fresnel gas lens and the cavity wall of the Fresnel gas lens is formed a Fresnel lens.

10. The solar apparatus according to claim 1, further comprising a controller configured for controlling the driving mechanism to expand or retract the curtain-type reflecting surface according to a control signal, the control signal including at least one selected from the group consisting of: a signal from a clock, a signal from an external wind speed and direction measuring device, and manual instructions or weather forecast information received by a wired or wireless communication device.

11. The solar apparatus according to claim 1, further comprising a cleaning device arranged on the superficies of the first light receiving surface for cleaning the first light receiving surface, the cleaning device being selected from a movable disc-type vacuum cleaner or a slidable rod-type vacuum cleaner.
